(19) United States
(12) Patent Application Publication
(10) Pub. No.: US 2014/0284980 A1
(43) Pub. Date: Sep. 25, 2014

(54) Two-Position Bolster Seat with Adjustable Height Pedestal

(71) Applicant: Edward Francis Dick, JR., Shady Side, MD (US)

(72) Inventor: Edward Francis Dick, JR., Shady Side, MD (US)

(21) Appl. No.: 13/849,502

(22) Filed: Mar. 23, 2013

(51) Int. Cl. B63B 29/04; F16M 11/26

(52) U.S. Cl. CPC B63B 29/04; F16M 11/26
USPC 297/331; 248/157

(57) ABSTRACT

A bolster seat design for providing a standing position (FIG. 1) or leaning/sitting position (FIG. 2). In the standing position the arms (items 2, 3) are rotated to the vertical position. In the leaning/sitting position the arms are rotated to the horizontal position.

In addition, a pedestal (item 1) has been designed to change the height of the seat or other devices. By pressing down on a foot lever, the height can be changed quickly and easily.

### CROSS-REFERENCE TO RELATED APPLICATIONS

This application claims the benefits of provisional patent application Ser. No. 61/624,405, filed Apr. 16, 2012 by the present inventor.

### BACKGROUND

1. Prior Art

The following is a tabulation of some prior art that presently appears relevant:

U.S. Patents

| | | | |
|---|---|---|---|
| 6,692,076 | Feb 4, 2002 | Burer; Peter J | 297/331 |
| 4,010,926 | May 26, 1976 | Carnahan; Garnett H. | 248/411 |
| 5,619,949 | Apr. 15, 1997 | Dick; Edward F. | 114/363 |

2. Description of Prior Art

It is commonly known that standing in a boat is a more comfortable position than sitting when the boat is encountering impacts from waves. The legs act as shock absorbers to isolate the upper body from the impacts. Standing also improves visibility, especially when the bow of the boat is high due to the boat acceleration or riding waves.

Standing while driving a boat can be a dangerous position when being thrown around by the impact from waves. Many people have been injured or killed after being thrown from their boats.

U.S. Pat. No. 6,692,076 shows a typical drop bottom bolster seat often used for boats travelling fast in rough water. The seat pan is in a horizontal position when sitting or a vertical position for standing. One of the problems with this type of seat for shallow cockpit boats, is the seated position has to be too high. This is because if it is not high enough, when changed to the standing position, the seat will not be where it needs to be to support the standing body. The seat has no height adjustment.

U.S. Pat. No. 4,010,926 shows a typical adjustable height pedestal. This pedestal has a clamping mechanism that clamps an inner and outer telescoping tubes together. Two disadvantages of this pedestal are;

a) That to change the height of the pedestal, you must reach below the seat and unclamp the mechanism, move the seat, then reclamp the mechanism without the seat moving. The patent described herein has a foot operated locking mechanism.

b) U.S. Pat. No. 4,010,926 does not have a positive locking mechanism. Marine seating standards (ABYC) require a positive locking pedestal (as with locking pins) for type A marine seating (for boats traveling over 5 mph). Clamps as shown in U.S. Pat. No. 4,010,926 can come loose and slide down.

U.S. Pat. No. 5,619,949, also written by the author of the patent described herein, shows a three position marine bolster seat, Although the purpose of this patent is similar to the patent described herein, the mechanism is different. The new mechanisms are simpler in an effort to reduce costs and easy of operation.

### SUMMARY

Summarized is an improved bolster seat for boating. The adjustable bolster seat is designed to give the boat operator or passenger the option of either standing with back and side support, or changing the seat into a comfortable sitting or leaning position.

The pedestal is designed to allow the bolster seat occupant to change the height to suit their needs quickly and easily.

Accordingly several advantages are to provide an improved bolster seat. The advantages being occupant safety and comfort, along with an economical mechanical design which allows for simple and quick operation. Still further advantages will become apparent from a study of the following description and the accompanying drawings.

### OBJECT AND ADVANTAGES

The objective of this invention is a bolster seat that is economic, easy to use, and fits easily into a boat. The bolster seat will provide protection for the occupant from being thrown around inside or outside the boat while standing. The seat also converts into a leaning or sitting position for relaxed comfort.

Advantages are;

A simple and easy way to adjust the height of the seat pedestal.

Rotatable arms of the bolster seat can be changed from cushions to lean or sit on, to side cushions that support the occupant in the standing position.

### DRAWINGS

FIG. 1—Bolster seat shown in standing position

FIG. 2—Bolster seat shown in leaning position

FIG. 3—Arms shown in the vertical position, for standing in the bolster

FIG. 4—Arms shown in the horizontal position, for leaning

FIG. 5—Back view of telescoping pedestal

FIG. 6—Section view of telescoping pedestal

FIG. 7—Isometric view of telescoping pedestal

### DESCRIPTION/OPERATION

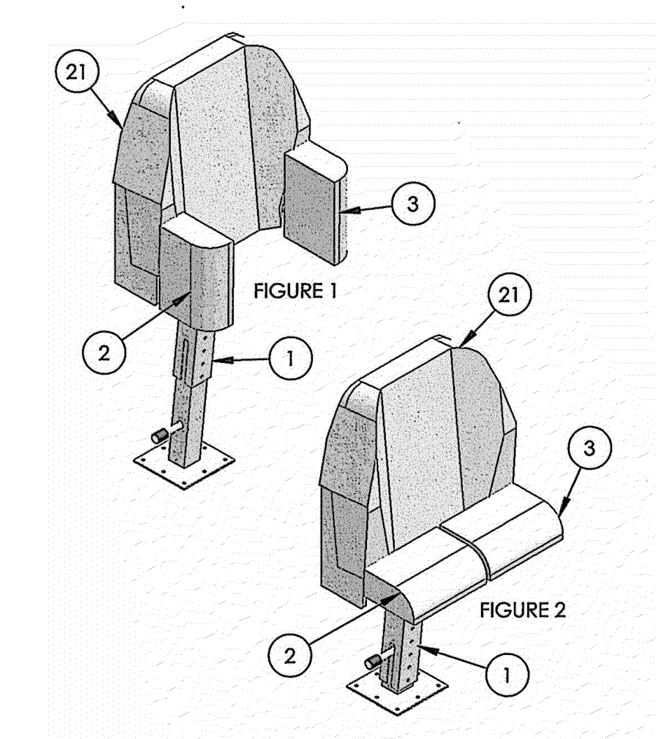

FIG. 1 shows the bolster seat in the standing position. This has the arms rotated in the vertical position, to support the occupant. The pedestal is adjusted to a high setting, to accommodate the occupant when standing.

FIG. 2 shows the bolster seat in the sitting or leaning position. The arms are rotated to horizontal position for the occupant to sit or lean on. The pedestal is adjusted to a lower setting, to allow the occupants feet to rest on the deck.

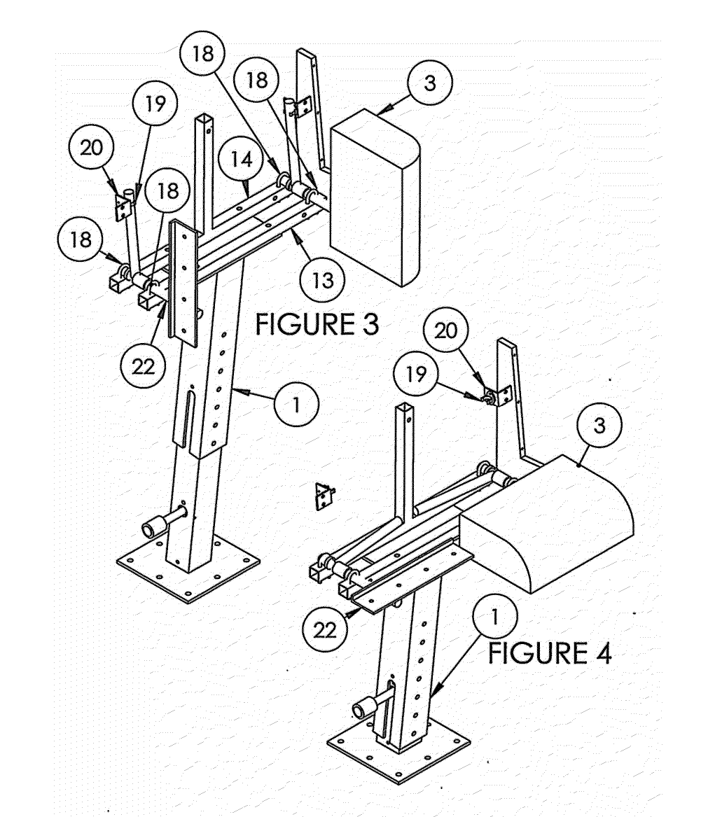

FIG. 3 shows the frame of the structure that allows the arms (item 2 and 3) to rotate from vertical (FIG. 3) to horizontal (FIG. 4). The arms are fastened to the arm frames (item 22). These arm frames rotate in arm pivot bearings (item 18). The horizontal position is set when the arm frame rotates inward and comes in contact with the rear bearing support tube (item 14). The vertical position is set when the arm frame rotates up and comes in contact with the arm snap clip (item 19). The snap clip holds the arm frame in the vertical position. The arm snap clip is fastened to the arm snap clip-mounting bracket (item 20). This bracket is fastened to the seat back (item 21).

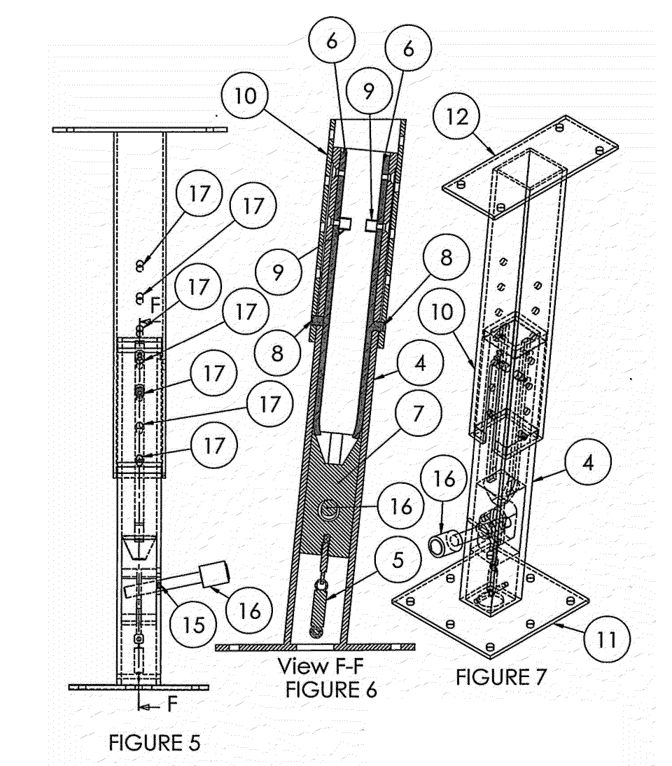

FIGS. 5, 6, and 7 show respectively, a back view, a section view, and an isometric view of the pedestal. To change the height of the pedestal, a person pushes down on the foot lever (item 16). The foot lever rotates around the foot lever pivot pin (item 15). The foot lever goes through a hole in the slider (item 7). When the foot lever is pivoted downward by the person's foot, the slider travels upward inside the inner telescoping tube (item 4). When traveling upward, the slider moves the flappers (item 6) inward. The flapper ends are resting on an angled surface of the slider, which forces them inward, when the slider travels up.

The locking pins (item 8), go through holes in the inner telescoping tube and engage in holes (item 17) in the outer telescoping tube (item 10). The inward movement of the flappers moves the locking pins, which are welded to the flappers, inward and disengage them from the holes in the outer telescoping tube. This allows the outer telescoping tube to be moved up or down, and reset at a different height. By releasing pressure on the foot lever, the flapper return springs (item 9) will re-engage the locking pins into the nearest hole. This resets the pedestal height.

### REFERENCE NUMERALS

| Item number | Description |
|---|---|
| 1 | Pedestal |
| 2 | Right hand arm |
| 3 | Left hand arm |
| 4 | Inner telescoping tube |
| 5 | Slider return spring |
| 6 | Flapper |
| 7 | Slider - its up and down motion moves flapper in or out |
| 8 | Locking pins welded to flappers |
| 9 | Flapper return springs |
| 10 | Outer telescoping tube |
| 11 | Deck mounting plate - welded to item 4 |
| 12 | Seat mounting plate - welded to item 10 |
| 15 | Foot lever pivot pin |
| 16 | Foot lever |
| 17 | Various holes for locking pins to engage into, - |
| | to adjust pedestal height |
| 18 | Arm pivot bearing |
| 19 | Arm snap clip - to hold arm in vertical position |
| 20 | Arm snap clip mounting bracket |
| 21 | Arm frame |

I claim:

1. An adjustable height pedestal, comprising;
a. inner and outer telescoping tubes which can be locked together by moveable pins.
b. a foot lever, which moves a sliding block inside the inner telescoping tube, that has angled surfaces which move pins to engage or disengage the pins that lock the inner and outer telescoping tubes together.

2. A bolster seat, comprising;
a. seat back
b. two side arms;
when rotated to the vertical position provide side support for the occupant standing in the bolster seat.
and when rotated to the horizontal position provide a seat for the occupant to rest their body.
